(19) United States
(12) Patent Application Publication
(10) Pub. No.: US 2015/0360168 A1
(43) Pub. Date: Dec. 17, 2015

(54) Combustion CO2 Recovery System

(71) Applicant: Pioneer Energy Inc, Lakewood, CO (US)

(72) Inventors: Robert Zubrin, Golden, CO (US); Mark Berggren, Golden, CO (US); Stacy Lorraine Carrera, Golden, CO (US); Peter Lester Jonscher, Centennial, CO (US)

(73) Assignee: PIONEER ENERGY INC, Lakewood, CO (US)

(21) Appl. No.: 14/736,244

(22) Filed: Jun. 10, 2015

Related U.S. Application Data
(60) Provisional application No. 62/011,002, filed on Jun. 11, 2014.

(51) Int. Cl. B01D 53/04

(52) U.S. Cl. CPC B01D 53/0438; B01D 2253/116; B01D 2253/102; B01D 2256/22; B01D 2257/504; B01D 2259/4009; B01D 2259/403; B01D 2259/404; B01D 2259/4566

(57) ABSTRACT

Novel methods for capturing carbon dioxide from internal combustion engines, gas turbines, and other combustion sources operating on a wide range of gaseous, liquid, or solid fuels are described. Capturing carbon dioxide from combustion exhaust on an absorbent and then regenerating the absorbent for recovery, storage, use, or sequestration of concentrated carbon dioxide are described herein.

### RELATED APPLICATIONS

This application claims the benefit of U.S. Provisional Application No. 62/011,002 filed Jun. 11, 2014, titled “Combustion CO2 Recovery System” which is incorporated herein by reference.

### BACKGROUND OF THE INVENTION

Interest in the recovery of carbon dioxide has increased due to several factors. The commercial CO₂ market is thriving. There is renewed interest in the enhanced oil recovery (EOR). In addition, carbon dioxide is the leading cause of global warming and its reduction in the air is important to reducing greenhouse gas effects on water levels and global temperatures. As a result, there is interest in capturing and sequestering the carbon dioxide produced by combustion systems.

Carbon dioxide is used in the food industry in carbonated beverages, and flash drying.

Industrial uses include enhanced oil recovery (EOR), welding, chemical feedstock, inert gas, firefighting, and solvent extracting as a supercritical fluid. It is also a critical component of medical oxygen, where in low concentrations it acts a breathing stimulant.

Enhanced oil recovery is one of the largest markets for recovered carbon dioxide. In EOR, carbon dioxide is miscible with oil at elevated pressure. This property is exploited to boost the mobility of oil through geologic formations, resulting in significantly improved oil recovery at production wellbore.

Emission of greenhouse gases such as carbon dioxide, if left unchecked, may potentially affect climate conditions. With continued use of fossil fuels, capturing carbon dioxide emissions directly from the source of combustion could reduce its effect on our planet and its inhabitants. New regulations require reductions in the carbon dioxide released by power plants. Under these regulations, it may not be possible to operate coal fired power plants at all unless a substantial fraction of their carbon dioxide emissions can be captured.

Many studies and methods have been established to capture carbon dioxide from combustion plants and sources such as flue gas.

### BRIEF DESCRIPTION OF DRAWINGS

FIG. 1 Process flow diagram of sorption/hot CO₂ regeneration system

FIG. 2 Process flow diagram of sorption/H₂O regeneration system

FIG. 3 Experiment 1: Sorption Results

FIG. 4 Experiment 1: Regeneration Results

FIG. 5 Experiment 1: Cooling Results

FIG. 6 Experiment 2: Sorption Results

FIG. 7 Experiment 2: Regeneration Results

FIG. 8 Experiment 2: Cooling Results

FIG. 9 Experiment 3: Sorption Results

FIG. 10 Experiment 3: Regeneration Results

FIG. 11 Experiment 3: Cooling Results

FIG. 12 Experiment 4: Sorption Results

FIG. 13 Experiment 4: Regeneration Results

FIG. 14 Experiment 4: Cooling Results

FIG. 15 Experiment 5: Experimental Profile for Second Method using Desorption with Steam

### DETAILED DESCRIPTION OF THE DRAWINGS

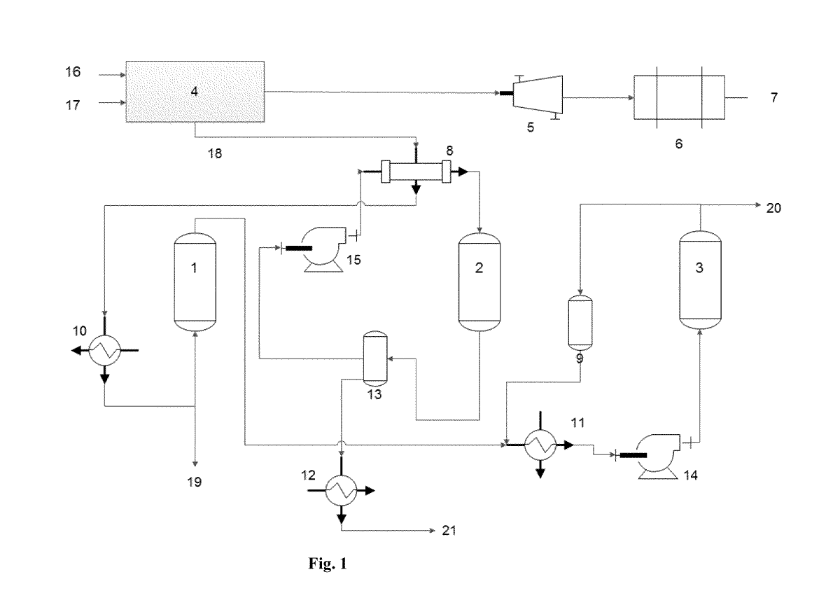

FIG. 1 illustrates the sorption of CO₂ and the subsequent recovery of nearly pure CO₂ with simultaneous regeneration of the sorbent material using a hot CO₂ regeneration method. Key components of the CO₂ sorption/hot CO₂ regeneration system include a sorption vessel (1), a regeneration vessel (2), and a cooling vessel (3). The system is directed toward recovery of CO₂ produced by combustion in an engine (4) or other combustion device used for electrical power generation via a turbine (5) and electrical power generator (6) to produce electricity (7). A heat exchanger (8) transfers thermal energy from the exhaust gas (18). Surge tanks (9) and (13) are used to facilitate system pressure control for recycled gases. A heat exchanger (10) is used to further cool combustion gases prior to moisture removal. Additional heat exchangers (11) and (12) are used to cool nitrogen-rich gas used for cooling sorbent and for cooling CO₂ product, respectively. A blower (14) is used to recycle cooled nitrogen-rich gas to cool sorbent in vessel (3). Another blower (15) is used to recycle CO₂-rich gas recycled to vessel (2) for the purpose of hot CO₂ gas recovery and sorbent regeneration. Natural gas or other fuel (16) is burned in combustion device (4) by air (17), producing hot combustion gas (18). Water condensed and cooled from combustion gas (19) is removed from the system. Dry nitrogen-rich gas (20) is vented from the system following use a sorbent cooling agent. CO₂ (21) is collected from the sorbent regeneration system as a concentrated product.

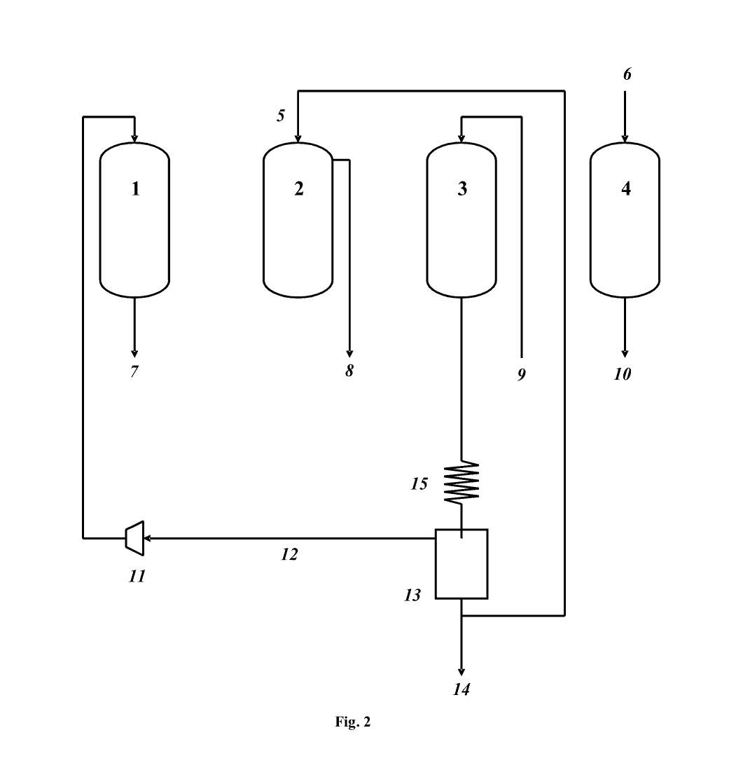

FIG. 2 illustrates the sorption of CO₂ and the subsequent recovery of nearly pure CO₂ using a water or steam regeneration method. Key components include a CO₂ sorption vessel (1), a CO₂ recovery vessel (2), a water removal vessel (3), and a cooling vessel (4). The system is directed toward recovery of CO₂ produced by combustion in an engine or other combustion device used for electrical power generation or other purposes. Hot engine exhaust (9) is used to heat sorbent for removal of water that is cooled (15), collected in a reservoir (13), and then in part recovered and recycled (5) as feed to vessel (2) for displacement and recovery of CO₂ product (8). Remaining water is discharged from the system (14). Dry, cool combustion gas (12) collected in this manner is passed through a blower (11) to provide a pressure boost to overcome pressure drop in sorbent vessel (1). A nitrogen-rich gas (7) exhausts sorbent vessel (1) to atmosphere. Air (6) is used to cool sorbent in vessel (4) prior to initiation of a CO₂ sorption cycle. The cooling air is exhausted (10) to atmosphere.

### DETAILED DESCRIPTION OF THE INVENTION

An important aspect of the present invention is a process for recovering carbon dioxide from combustion exhaust gases.

In one embodiment, the present invention captures carbon dioxide from internal combustion engines, gas turbines, and other combustion sources operating on a wide range of gaseous, liquid, or solid fuels. A novel method of capturing carbon dioxide from combustion exhaust on an absorbent and then regenerating the absorbent for recovery, storage, use, or sequestration of concentrated carbon dioxide is described in another embodiment.

In one embodiment there is provided, a method of capturing carbon dioxide from a combustion source exhaust where the carbon dioxide is captured with a sorbent bed such as a molecular sieve, preheated carbon dioxide is passed through the sorbed bed to free the trapped carbon dioxide, collection of the desorbed carbon dioxide for other applications, and regeneration of the sorbent bed with a cooling gas such as nitrogen to restart the cycle of carbon dioxide capture process.

In one embodiment the preheated carbon dioxide used to regenerate the bed and free the trapped carbon dioxide is heated using a portion of the thermal energy released by the combustion source.

In one embodiment the molecular sieve bed is cooled after regeneration using the nitrogen-rich and CO₂-poor gas remainder exiting from the sorption bed.

In one embodiment a supply of CO₂ used to regenerate said molecular sieve is stored in a surge tank, and drawn from a source including but not limited to the combustion source exhaust.

In one embodiment the carbon dioxide source is flue gas.

In one embodiment for recovering carbon dioxide, the method shown in FIG. 1 uses a conventional stationary internal combustion engine (4), gas turbine (5), other combustion system, or other type of CO₂ emitter operating on a wide range of gaseous, liquid, or solid fuels is used to power an electrical generator (6) to generate electrical power (7) or is used for other purposes. The engine or turbine uses air (17) to combust the fuel (16), resulting in exhaust gas (18) consisting mostly of nitrogen, carbon dioxide, and water vapor. Minor amounts of excess oxygen and part-per-million levels of combustion byproducts such as carbon monoxide, nitrogen oxides, and sulfur oxides are also present in the exhaust gases. The combustion source or turbine exhaust gas passes through a series of three identical vessels (1, 2, 3) after temperature and flow adjustments as shown in FIG. 1.

The CO₂ recovery system operates with continuous gas flow (18) from the combustion source, but the flow path is routed as required as each of the three vessels cycles through the sorption (1), regeneration (2), and cooling (3) steps described herein. A set of valves sequentially changes the combustion gas flow path so that each of the three vessels operates in sorption, CO₂ regeneration, and cooling modes.

Operating cycle times for absorption, regeneration, and cooling are identical so that the engine or turbine exhaust gases are always directed to the vessel in CO₂ sorption mode. The operating cycle time is not critical to the invention, but is selected on the basis of the exhaust gas composition and flow rate with consideration for minimizing vessel sizes.

The combustion source exhaust gas (18) is first cooled (8, 10) to condense water (19), which is removed in a separator upstream of a CO₂ absorbing vessel (1). The dry, CO₂ containing exhaust gas is fed to a sorption vessel (1) containing molecular sieve, activated carbon, or other CO₂-selective sorbent. FIG. 1 shows an upflow configuration, although the flow direction is not critical to the invention.

The CO₂ absorbing vessel (1) selectively separates CO₂ from N₂. The CO₂ absorbing vessel is designed to remove a high percentage of CO₂ from the exhaust gas (greater than 50 percent and preferably 90 percent or more).

Next, the CO₂ depleted exhaust gas from the CO₂ absorber vessel is cooled and directed to the cooling vessel (3), as described later below.

After CO₂ sorption in the first vessel, the absorption vessel (1) is configured to be operated as a regenerator vessel (2). In this mode, using a recycle blower (15), a recirculating stream using of CO₂ gas is used to heat the sorbent to a temperature greater than about 200° C. in order to release sorbed CO₂.

Ideally, the regeneration flow direction would be opposite from that used for sorption, although this is not critical to the overall results obtained.

The released CO₂ combines with the recirculating CO₂ and is drawn off for storage by cooling (12), compression, and/or liquefaction) (21).

The temperature of the recirculating CO₂ is raised using heat indirectly recovered from the combustion source in a heat exchanger (8). Because the combustion source exhaust temperature is greater than 400° C. and as much as 600° C. or more, the recirculating CO₂ gas stream can be used to heat the sorbent bed (2) to the desired temperature of greater than 200° C.

A recycle blower (15) is used to recirculate the CO₂ used for regeneration at a rate that achieves the desired sorbent bed (2) temperature rise in a time period matching that used for CO₂ sorption in vessel (1). The surge tank (13) assists in achieving pressure control and the appropriate recycle rate.

The CO₂ depleted gas exhausting from sorption vessel (1) is cooled and directed through the cooling vessel (3). A recycle blower (14) is used to recycle the CO₂ depleted gas through the cooling vessel (3) at a rate required to reduce the sorbent temperature to less than 50° C. and preferably less than 40° C. in preparation for re-use of the sorbent as described for vessel (1). The surge tank (9) assists in pressure control and making the appropriate recycle rate for the cooling step.

The cooling gas flow direction is ideally opposite that used for regeneration, although this is not critical to the overall results obtained.

Note that any CO₂ not captured in vessel (1) has an opportunity to be captured in vessel (3) prior to venting to the atmosphere. The combustion source exhaust (18) contains sufficient heat to satisfy the thermal requirements to raise the sorbent in vessel (2) to greater than 200° C. (including the heat of desorption of CO₂ and the heating of the sorption media).

Air cooled radiators and/or heat exchangers (10, 11, and 12) can be used to remove excess system heat. Optionally, a desiccant drying bed can be installed after the heat exchanger/cooler and inlet of vessel (1).

Hot carbon dioxide is used to heat the sorbent in vessel (2) to recover carbon dioxide sorbed from the combustion source exhaust. By heating the sorbent to a sufficient temperature (greater than about 200° C.), the sorbed CO₂ in vessel (2) is released and collected in nearly pure gaseous form. After desorption of the CO₂ (2), the sorbent bed (3) is cooled as depicted in vessel (3) with a flow of dry nitrogen.

In another embodiment for recovering carbon dioxide, the method shown in FIG. 2 uses a conventional stationary internal combustion engine, gas turbine, or other combustion source operating on a wide range of gaseous, liquid, or solid fuels is used to power an electrical generator or is used for other purposes. The engine or turbine uses air to combust the fuel, resulting in exhaust gas consisting mostly of nitrogen, carbon dioxide, and water vapor. Minor amounts of excess oxygen and part-per-million levels of combustion byproducts such as carbon monoxide, nitrogen oxides, and sulfur oxides are also present in the exhaust gases. The engine or turbine exhaust gas passes through a series of three identical vessels for water removal (3), CO₂ sorption (1), and CO₂ recovery (2). Air is passed through a fourth vessel (4) to cool the sorbent prior to initiating the next process cycle. A set of valves sequentially changes the gas flow path so that each of the vessels operates in water removal, CO₂ sorption, CO₂ recovery, and cooling modes.

Water or preferably steam (5) is used to recover carbon dioxide (8) sorbed from the combustion source exhaust rather than hot CO₂ as in the first method. Typical molecular sieves, activated carbons, and other CO₂ absorbents can be regenerated thermally (as in the first method above). However, because molecular sieves, activated carbon, and other CO₂ sorbents have a stronger affinity for H₂O than for CO₂, H₂O can be used to displace CO₂ that was recovered on absorbents as an alternative to thermal regeneration. Water addition to a sorbent bed releases nearly pure CO₂ as H₂O displaces sorbed CO₂.

The combustion CO₂ recovery system operates with continuous gas flow from the engine or turbine, but the flow path is routed as required as each of the four vessels cycles through the absorption (vessel 1), regeneration (vessel 2), water removal (vessel 3), and cooling (vessel 4) steps described herein.

Operating cycle times for absorption, regeneration, water removal, and cooling are identical so that the combustion source or turbine exhaust gases are always directed to one of the four vessels while in CO₂ sorption mode. The operating cycle time is not critical to the invention, but is selected on the basis of the exhaust gas composition and flow rate with consideration for minimizing vessel sizes.

The second method is described here by following the flow path of combustion source exhaust through the four-bed system. Hot combustion source exhaust (9) is first passed through vessel (3) in FIG. 2 to evaporate H₂O that was used to remove CO₂ that was previously sorbed in vessel (2). When vessel (3) reaches a temperature greater than about 250° C., sorbed H₂O is removed. At this temperature, water vapor contained in the combustion source exhaust is not further absorbed. Therefore, the absorbent is free of CO₂ and H₂O and can be prepared for further sorption by cooling.

The regenerated sorbent is cooled via a flow of ambient temperature air (6) as shown in vessel (4) in FIG. 2. The air can be introduced as a one-pass flow or as a recirculating flow with cooling after each pass. The cooling air should be of low humidity to prevent absorption of H₂O that could reduce the absorbent capacity for CO₂ during the next sorption cycle.

After the combustion gas exhausts vessel (3), it is cooled (15) to a temperature preferably below dew point to remove most of the water vapor (by indirect heat exchange and/or active refrigeration).

The cooled exhaust gas is next passed through a pressure boost blower (11) prior to introduction to vessel (1), the CO₂ sorption column. The absorbent in vessel (1) preferentially sorbs CO₂ (as well as residual moisture contained in the dried exhaust gas). Sorption of CO₂ results in a temperature rise in vessel (1). The CO₂ and H₂O free gas (7) exiting vessel (1) is released to atmosphere. Alternatively, this gas may be used as a recirculating cooling gas (6, 10) in vessel (4) according to the procedures outlined previously.

Once the absorbent in vessel (1) has attained its target CO₂ sorption capacity, it is subjected to regeneration by the addition of H₂O as represented in vessel (2). H₂O (5) is added in the form of steam or liquid water to displace CO₂. Ideally, one molecule of water will displace one molecule of carbon dioxide, resulting in the requirement that 18 grams of water will displace 44 grams of carbon dioxide. In practice, more water may be needed (two, three, or more times the ideal amount) if the water is sorbed on unoccupied absorbent sites before it displaces sorbed carbon dioxide. The CO₂ released upon H₂O addition is nearly pure, with only small amounts of nitrogen, oxygen, and other trace gases present from interstitial spaces between sorbent particles or released from sorbent upon water addition. The net effect of water sorption and carbon dioxide desorption results in a temperature rise in the sorbent bed, which reduces the heating requirement in vessel (3).

### Experimental

The following procedures may be employed for the recovery of carbon dioxide from internal combustion engines, gas turbines, or other combustion sources used as described in the present invention. A commercially-available molecular sieve adsorbent used was used for experiments described herein. Compressed gases used to comprise simulated combustion source exhaust gases were available from a commercial supplier as well. The gas composition sensor and gas chromatograph used for calculations were also commercially available.

Reactor system set-up: To simulate the entire system, dry carbon dioxide blended with nitrogen from pressurized cylinders was used instead of combustion source exhaust. One stainless steel reactor was used for three steps consisting of sorption, regeneration, and cooling by switching valves between each step. The gas can be changed by switching valves as we have done for these initial experiments, or the sorbent bed can be moved between vessels. The dimension of the cylindrical reactor was ten inches tall by three inches diameter. Insulation covered the entire reactor. Mass flow meters and controllers were used to adjust and measure the flow rate of the carbon dioxide/nitrogen gas mixture. A LabView control system was used to control and monitor the system. An infrared CO₂ sensor was located on a slipstream off an exhaust flow meter and dry test meter. The flow to the infrared sensor was controlled using a rotameters set to 0.5 liters per minute. The CO₂ sensor was used to verify the sorption inlet and exhaust gas compositions from the sorption, regeneration, and cooling steps.

### Procedure—First Method

Experiment 1: For this experiment carbon dioxide was sorbed onto a molecular sieve at a flow rate of 50 liters per minute with ten percent being carbon dioxide and the remaining being nitrogen. For the regeneration process, pre-heated carbon dioxide at a flow rate of 100 liters per minute was then used to remove the sorbed carbon dioxide from the sorption bed. Lastly, nitrogen at a flow rate of 100 liters per minute was used to cool the sorption bed, readying it for another cycle.

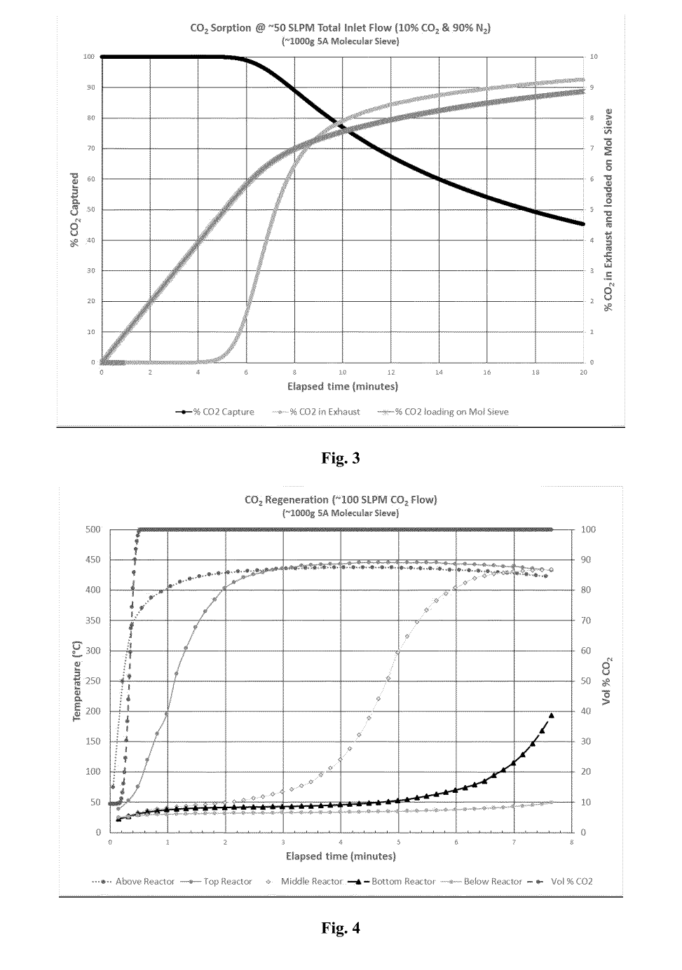

This first chart (FIG. 3) shows the results of the sorption process. In the black is the cumulative percent CO₂ fed that is captured by the sorbent bed. There is 100 percent captured for the first six minutes at which time the carbon dioxide begins to breakthrough and can be detected by the infrared sensor. The light grey shows the percent CO₂ in the exhaust, which is zero for the first five minutes and starts increasing after this time. The dark grey shows the mass percent loading of CO₂ on the molecular sieve during the sorption process. It increases linearly until around the six minute mark and then starts leveling off In general, it is preferred to regenerate in the opposite direction of flow used for sorption, but it is not critical to the invention.

The second chart (FIG. 4) shows the results of the regeneration process. This chart shows the volume percent carbon dioxide in the exhaust taking into account the amount of CO₂ used to regenerate the sorbent bed. After displacing nitrogen present in interstitial spaces between absorbent particles, the exhaust gas contained 100 percent CO₂. The slight increase in flow rate resulting from CO₂ desorption is difficult to measure with these preliminary studies but the ability of the sorbent bed to capture more CO₂ in the subsequent tests was proof that the regeneration process was successful. Results from these subsequent cycles are summarized below. The chart also shows the temperature profile above the reactor, at the top, middle and bottom of the reactor, and below the reactor. The CO₂ is preheated to 400-450° C. prior to flowing over the sorbent bed. The process was stopped when the bottom of the reactor reached 200° C.

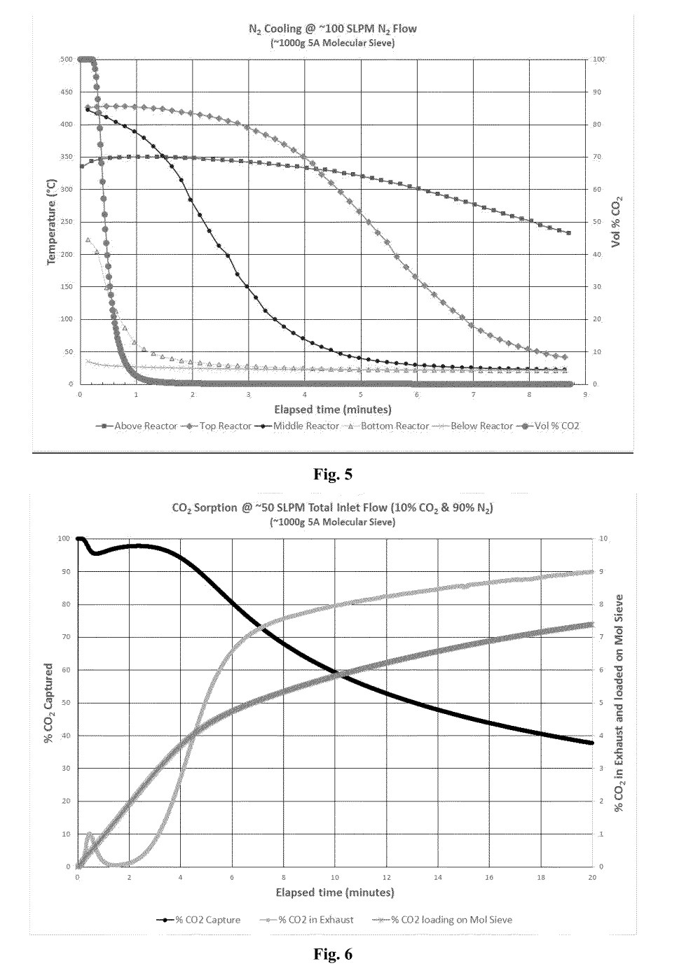

The next chart (FIG. 5) shows the results of the cooling process. Nitrogen was flowed at 100 liters per minute to cool the sorbent bed. Shown in the chart are the temperature profile above the reactor, at the top, middle and bottom of the reactor, and below the reactor. The direction of flow was upward to remove the heat quickly and was stopped when the top of the reactor was below 50° C. Also shown in the chart is the volume percent CO₂, which shows a small amount of carbon dioxide only within the first 20 seconds indicating nearly complete recovery of CO₂ during regeneration.

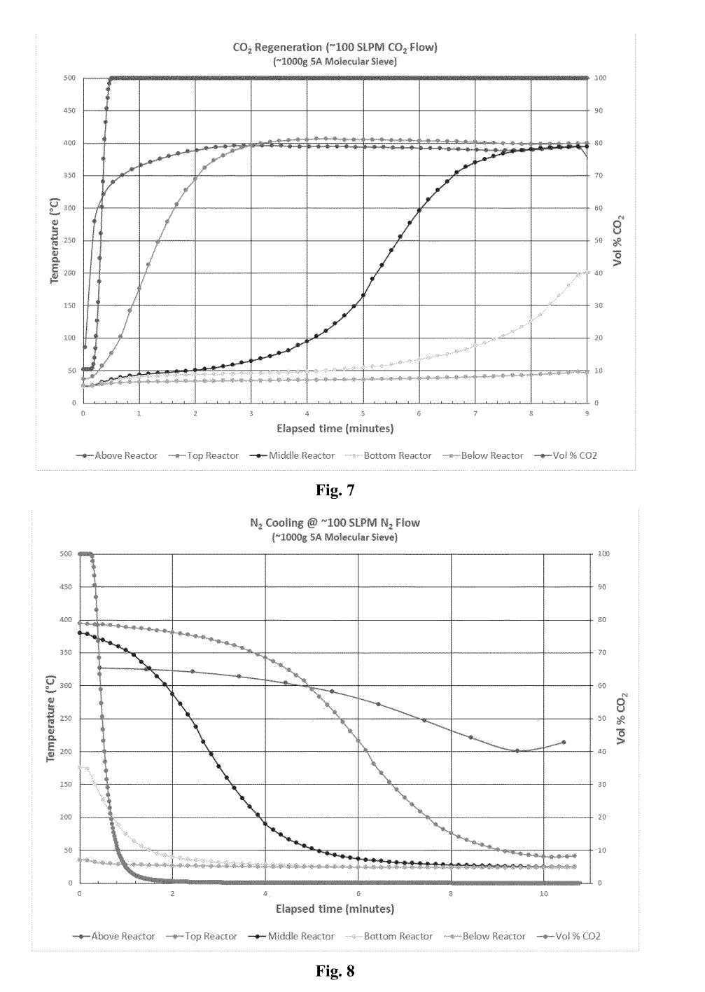

Experiment 2: To confirm that the molecular sieve adsorption capacity was not affected and was freed up during the regeneration process, the previous experiment was repeated. The results (FIGS. 6, 7 and 8) confirmed that carbon dioxide can continually be sorbed during multiple cycles.

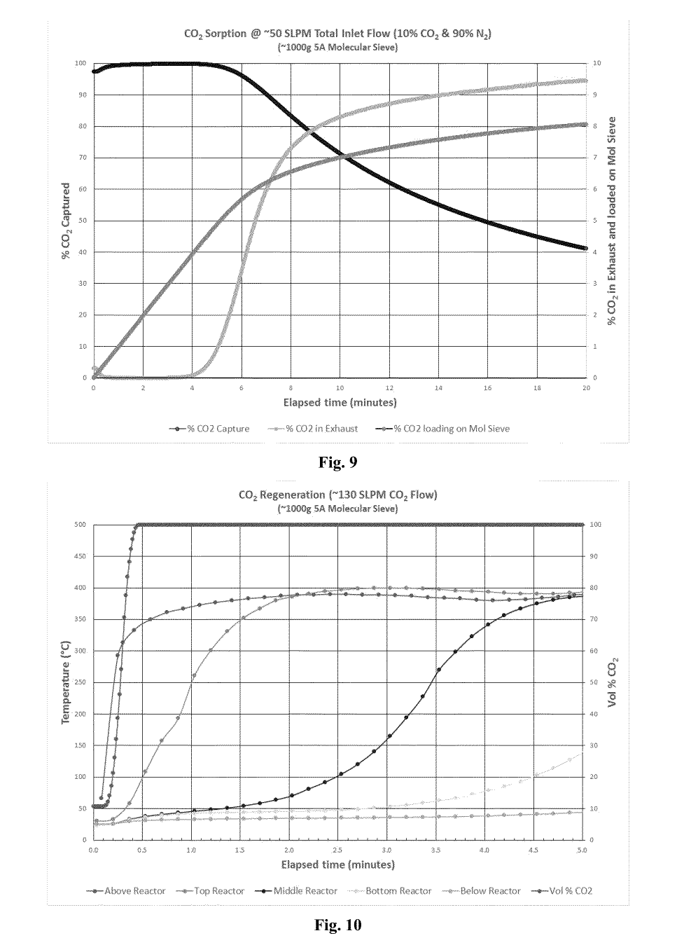

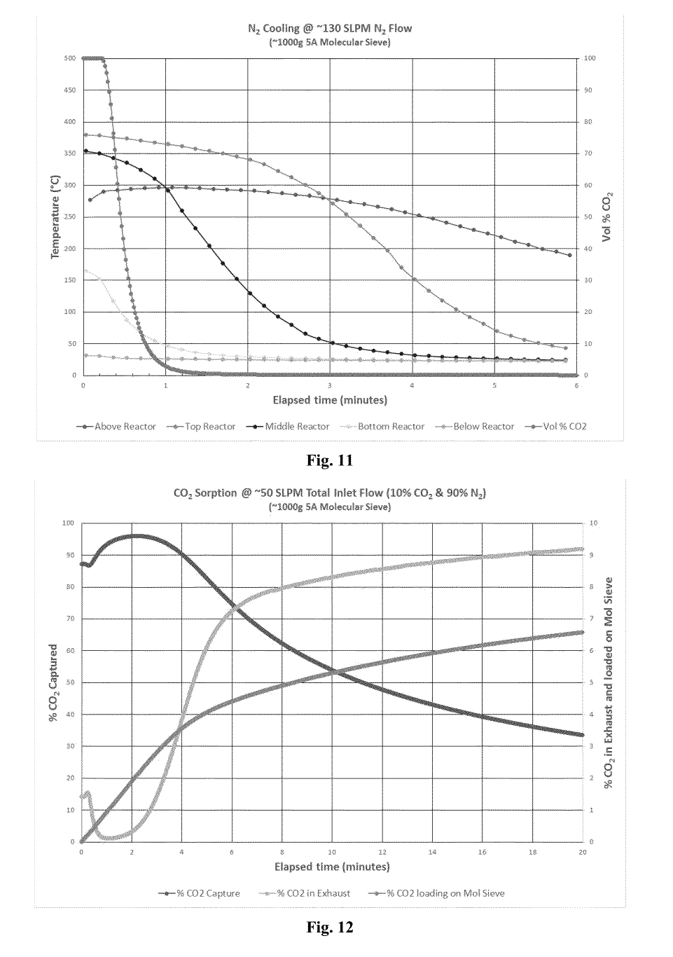

Experiment 3: For an optimized process, the regeneration and cooling steps would ideally match the time cycle of the sorption step. For this experiment the sorption process (FIG. 9) stayed at 50 liters per minute but the regeneration (FIG. 10) and cooling (FIG. 11) flow rates were increased to approximately 130 liters per minute which more closely matched the cycle time of the regeneration process.

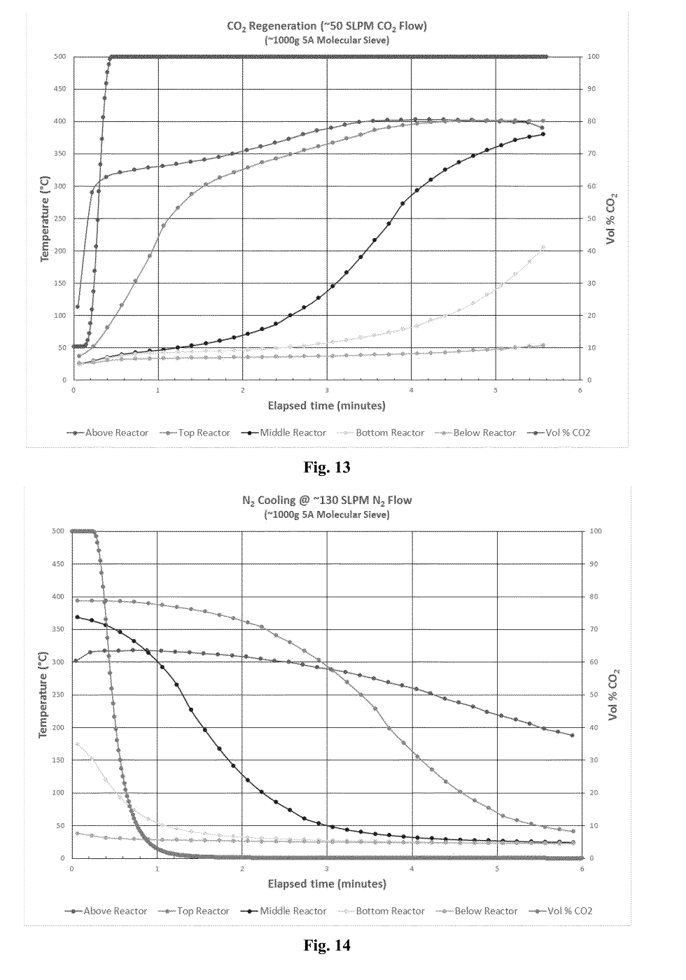

Experiment 4: The final experiment for this method repeats the previous experiment to demonstrate the ability of regenerating the sorbent bed after sorption for multiple cycles. The regeneration process stayed at 50 liters per minute and the regeneration and cooling flow rates were approximately 130 liters per minute which more closely matched the cycle time of the regeneration process. Again, the results show that the sorbent bed can capture the carbon dioxide (FIG. 12) and then can be regenerated with pre-heated carbon dioxide (FIG. 13) and then cooled quickly to ready for another cycle (FIG. 14).

### Experimental—Second Method

The following procedures may be employed for the recovery of carbon dioxide from internal combustion engines or gas turbines used as described in the present invention. A commercially-available molecular sieve adsorbent used was used for experiments described herein. Compressed gases used to comprise simulated combustion source exhaust gases were available from a commercial supplier as well. The gas composition sensor and gas chromatograph used for calculations were also commercially available.

Reactor system set-up: To simulate the entire system, dry carbon dioxide blended with nitrogen from pressurized cylinders was used instead of combustion source exhaust. One stainless steel reactor was used for the four steps consisting of sorption, regeneration by water addition, water removal, and cooling by switching valves between each step. The dimension of the cylindrical reactor was ten inches tall by three inches diameter. Insulation covered the entire reactor. Mass flow meters and controllers were used to adjust and measure the flow rate of the carbon dioxide/nitrogen gas mixture. A LabView control system was used to control and monitor the system. An infrared CO₂ sensor was located on a slipstream off an exhaust flow meter and dry test meter. The flow to the infrared sensor was controlled using a rotameters set to 0.5 liters per minute. The CO₂ sensor was used to verify the sorption inlet and exhaust gas compositions from the sorption, regeneration, and cooling steps.

### Procedure

Scouting Experiments: A series of experiments was run to establish procedures and preliminary results of the effectiveness of using liquid water and steam to displace the CO₂ sorbed onto molecular sieve 5A. The scouting experiments verified that CO₂ could be released from the molecular sieve upon introduction of water. Steam was found to be preferred over liquid water due to improved dispersion in the absorbent bed. CO₂ released from the absorbent was directly measured upon water addition, and the absorbent was regenerated as evidenced by its ability to sorb CO₂ during subsequent experiments.

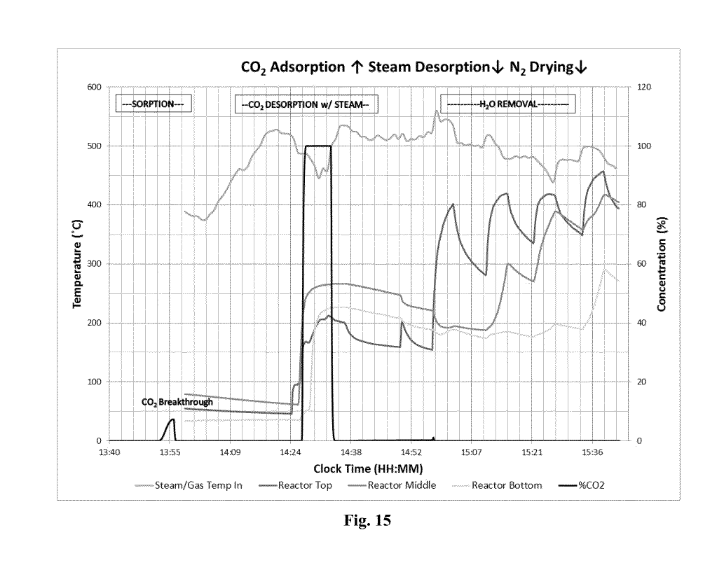

Experiment 5: For this experiment carbon dioxide was sorbed onto a molecular sieve at a flow rate of 50 liters per minute. The procedures and results for the CO₂ sorption were similar to those for Experiment 1 of the First Method described above. For regeneration of the absorbent bed, water was injected as steam in three separate injections totaling about four times the theoretical amount of water required over about seven minutes. During this time, CO₂ was desorbed from the absorbent in an amount approximating the amount sorbed. During the steam injection step, the absorbent bed temperature rose from about 50° C. to as high as about 250° C. due to heat of sorption of water vapor. Next, dry nitrogen was used at a rate of about 88 standard liters per minute to heat the absorbent to desorb water in preparation for the next cycle. The dry nitrogen was introduced at about 500° C. during four separate two minute segments. After each segment, water collected in the exhaust gas condenser was measured (not all water evolved from the absorbent was collected in the condenser). However, approximately 80 percent of the water injected as steam was recovered as condensate in this experiment. FIG. 15 illustrates the experimental profile for the experiment.

Following the procedures outlined above, dry ambient temperature nitrogen was used to cool the absorbent in preparation for another CO₂ sorption cycle.

### System Analysis

### First Method (Hot CO₂ Regeneration)

A key to the present invention is the effective use of thermal energy contained in the hot CO₂-containing exhaust gas to regenerate the absorbent by removal of CO₂ in preparation for a subsequent absorption step.

A flow rate of 500,000 standard cubic feet per day (SCFD), or 14,158,000 standard liters per day (SLPD), or 9832 standard liters per minute (SLPM), or 19.3 kilograms per minute of CO₂ produced from a combustion source was used for the thermal analysis presented below. For simplicity, the combustion source was considered to be pure methane. Such a system would have a thermal power of about 5.8 MW. Roughly similar results would be obtained with natural gas or other hydrocarbon fuels. The presence of ethane and propane such as in typical natural gas would increase the available heat compared to that described below.

As a basis for a thermal analysis, a three-bed system such as that depicted in FIG. 1 would be used. A cycle time of six minutes is specified for each step (CO₂ sorption, CO₂ regeneration, and absorbent cooling) to capture an amount of CO₂ equal to 6 weight percent of the absorbent present. Each absorbent bed contains 1930 kilograms of sorbent to accommodate the specified six minute cycle time.

Assuming stoichiometric combustion of methane fuel in air, a resulting gas mixture would contain 9.50 volume % CO₂, 19.00 volume % H₂O, and 71.49 volume % Nz. After removing water, the resulting dry exhaust gas would contain 11.73 volume % CO₂ and 88.27 volume % N₂. These gas compositions result from the combustion of 9826 SLPM of methane in 96,520 SLPM of air. A total wet exhaust flow rate of 103,413 SLPM results, which after removal of water vapor results in a dry flow rate of 83,670 SLPM.

During absorption of the dry exhaust gas as described above, heat is generated such that if the starting temperature of the absorbent bed were 40° C., the average temperature would be 97° C. after absorbing CO₂ in an amount of 6 percent by weight of absorbed CO₂. This temperature is calculated from the adiabatic temperature rise of sorbent resulting from the release of −44.9 kiloJoules (kJ) of energy per mole (44 grams) of CO₂ sorbed. The calculation assumes an absorbent heat capacity of 1.07 kJ/kg-C.

The heat of absorption as described above would take place in a fully insulated vessel. On a smaller scale, heat losses to the surroundings would be appreciable. However, in a larger vessel such as that containing 1930 kg of sorbent, heat losses would be substantially lower and the resulting temperature rise from absorption would be closer to the adiabatic value.

After absorption of CO₂, the absorbent is heated in a recirculating flow of CO₂ such that the temperature of the absorbent can be increased from approximately 97° C. to about 200C, at which temperature CO₂ is released from the absorbent. For this temperature rise to occur in the 6 minute cycle time, a total energy input of 330,874 kJ is required (118,169 kJ to release sorbed CO₂ and 212,705 kJ to heat the absorbent particles). The total energy over a six minute cycle time is equivalent to 919 kW of thermal power requirement. This can be met by indirectly recovering heat from the exhaust source by reducing its temperature from 600° C. to 236° C. The recycle rate of indirectly heated CO₂ is adjusted to allow for the transfer of the required heat over the six minute cycle time. In a simplified example, if the average temperature of the indirectly heated CO₂ used for desorption is 550° C. and the average temperature of the CO₂ exiting the vessel is 200° C., a recirculating flow of dry CO₂ in the amount of 76,440 SLPM is required. This flow rate is a good match for indirect heat exchange against the wet exhaust gas rate of 103,413 SLPM. The indirect heat exchange between exhaust gas and recirculating CO₂ can be accomplished in part or in full via a gas-to-gas heat exchanger. Alternatively, some of the exhaust gas heat can be stored in a heat storage medium prior to transfer to the recirculating CO₂ stream.

The final step in the first method includes cooling of the absorbent bed after regeneration by hot CO₂. In the preferred approach, the moisture-free, and CO₂ depleted gas is cooled and recycled through the sorbent bed to cool its temperature from about 200° C. to 40° C. in preparation for the next sorption cycle. To cool a 1930 kg sorbent bed from 200° C. to 40° C. requires 330,416 kJ of heat removal, equivalent to 917.8 kW of thermal energy removal.

For a gas consisting essentially of nitrogen, and with an average cooling gas inlet temperature of 20° C. and an average outlet temperature of 120° C., a recirculating flow of 421,041 SLPM is needed over a six minute cycle time to satisfy the cooling requirement. Note that further chilling of the recirculating gas will reduce the recycling gas rate. Note also that any CO₂ remaining in the exhaust gas after absorption of CO₂ will be sorbed during the cooling step, thereby enabling nearly complete capture of CO₂ from the exhaust source.

In summary, the thermal analysis for the first method for CO₂ capture shows that sufficient energy is available to perform the required hot CO₂ regeneration method. The combustion exhaust gas cooled in such a manner minimizes additional cooling required for removal of water vapor prior to the CO₂ sorption step.

### Second Method (H₂O Regeneration)

The energy balance for the second method of CO₂ capture is based on the same combustion conditions described above for the first method. In this method, a four-bed system is employed rather than the three-bed system described above for the first method. The cycle time and sorbent mass per bed is the same 1930 kg as that described above, and the 6 percent by weight CO₂ sorption capacity is the same as that described above for the first method.

Because the sorption characteristics for the second method are virtually the same as that for the first method, the enthalpy of CO₂ sorption and bed temperature rise are the same. Therefore, the starting condition before regeneration by water injection for the second method is the same as that for the first method using hot, recirculating CO₂.

For regeneration of the absorbent bed via the second method, water (in the form of liquid water or steam) is injected and dispersed throughout the absorbent bed to displace CO₂. Because the efficiency of water injected into the bed is not perfect, some excess is required. For the example case described here, an amount of water equal to twice the ideal one molecule of water per molecule of carbon dioxide is injected as steam. The ideal case would require a ratio of 18 grams of water per 44 grams of carbon dioxide to be released. The example case uses 36 grams of water per 44 grams of carbon dioxide.

During regeneration of CO₂ by H₂O, heat will be generated by H₂O sorption onto the sorbent. Assuming that steam is used, the heat of sorption of water vapor of −75.4 kJ/mol will cause a temperature rise. As CO₂ is displaced by sorbed water, a heat of desorption of 44.9 kJ/mol will cause a temperature drop. For the example case in which a mass of 115.8 kg of CO₂ is desorbed over a 6-minute period using twice the theoretical amount of water, a temperature rise of 135° C. would occur in a fully insulated vessel. This would bring the absorbent temperature from 97° C. to 232° C.

The next step after regeneration of CO₂ by H₂O is to remove the water used to displace CO₂ from the absorbent. In the stated example, the absorbent (including sorbed water) is heated to 250° C. to remove moisture in preparation for the next operating cycle. Heat input to raise the absorbent temperature from 232° C. to 250° C. is 37,855 kJ. The heat input to desorb water from the absorbent is 396,688 kJ. The total energy input to remove water used to regenerate the absorbent is therefore 434,273 kJ. This is equivalent to 1206 kW of thermal power over the six minute cycle time. The total available thermal power from cooling the combustion exhaust gas from 600° C. to 300° C. is about 759 kW. Therefore, some supplemental heating energy input would be required to fully remove water from the absorbent under this example condition. It may be observed that the shortfall of some 450 kWt is only about 8 percent of the thermal output of the combustion system. The additional heat input can be provided by combustion of some additional amount of fuel using the high-temperature exhaust from such combustion to supplement the heat available from the primary combustion exhaust. For example, methane fuel burned in air at an amount representing about 10 percent of the primary fuel could be used to generate the required supplemental heat. If such combustion gas exhaust at 1600° C. were cooled by transfer of heat to the absorbent bed to 300° C., sufficient heat would be generated to satisfy the thermal energy requirements for the H₂O regeneration procedure.

It should be noted that a similar amount of supplemental heating would be required if only the theoretical amount of H₂O were used to displace CO₂ (rather than the twice theoretical amount used in the above example). This is because the lower amount of heat required to remove H₂O is offset by the greater amount of heat to raise the temperature of the absorbent (which does not heat as much with lower H₂O additions. Optimization of the absorbent selection, vessel configuration, cycle time, and other parameters would likely lead to reduced supplemental thermal energy input requirements for the H₂O regeneration method.

For both methods, alternative embodiments are possible where additional heat to support the desorption process can be supplied by other power systems not associated with the source of CO₂ to be captured. Such power systems could utilize fuel combustion, nuclear power, solar power, wind power, tidal power, hydroelectric power, or geothermal power, among others.

The entire disclosures of all documents cited throughout this application are incorporated herein by reference.

What is claimed is:

1. A method of capturing carbon dioxide from a combustion source exhaust comprising the steps of:
a) Capturing the carbon dioxide with a sorbent bed such as a molecular sieve,
b) Recycling preheated carbon dioxide through the sorbed bed to regenerate and free the trapped carbon dioxide,
c) Collecting the desorbed carbon dioxide for other applications,
d) Cooling the sorbent bed with a cooling gas such as nitrogen.

2. A method of claim 1 where the preheated carbon dioxide used to regenerate the bed and free the trapped carbon dioxide is heated using a portion of the thermal energy released by the combustion source.

3. A method of claim 1 where said molecular sieve is cooled after regeneration using the nitrogen-rich and CO₂-poor gas remainder exiting from the sorption bed.

4. A method of claim 1 where a supply of CO₂ used to regenerate said molecular sieve is stored in a surge tank, and drawn from a source including but not limited to the combustion source exhaust.

5. A method of claim 1 where the carbon dioxide source is flue gas.

6. A method of claim 1 where additional thermal energy needed for the regeneration step is provided by additional power sources beyond the combustion that produced the CO₂ itself.

7. A method of claim 1 where increased pressure is applied to the system that allows large quantities of gas to be more easily pumped.

8. A method of capturing carbon dioxide from the exhaust of an combustion source comprising of these steps:
e) Capturing the carbon dioxide with a sorbent bed such as a molecular sieve,
f) Recycling steam through the sorbed bed to free the trapped carbon dioxide,
g) Collecting the carbon dioxide for other applications,
h) Cooling the sorbent bed with a cooling gas such as nitrogen.

9. A method of claim 8 where the carbon dioxide source is flue gas.

10. A method of claim 8 where the steam used to regenerate the bed and free the trapped carbon dioxide is heated using a portion of the thermal energy released by the combustion source.

11. A method of claim 8 where said molecular sieve is cooled after regeneration using the nitrogen-rich and CO₂-poor gas remainder exiting from the sorption bed.

12. A method of claim 8 where the steam used for regeneration is collected from but not limited to the water condensed from the cooled combustion source exhaust.

13. A method of claim 8 where additional thermal energy needed for the regeneration step is provided by additional power sources beyond the combustion that produced the CO₂ itself.

14. A method of claim 8 where increased pressure applied on the system allows large quantities of gas to be more easily pumped.

15. An apparatus for capturing CO₂ from a gas stream comprising:
a) A gas stream containing CO₂
b) Three beds containing a material that is a strong sorbent for carbon dioxide.
c) A surge tank for containing a supply of carbon dioxide
d) A heat exchanger for heating a gas stream containing carbon dioxide
e) A heat exchanger for cooling a gas stream that has been depleted in carbon dioxide, wherein:
f) The three beds are used in alternation, with one sorbing CO₂ from the CO₂ containing gas stream, one being desorbed using high temperature CO₂ drawn from the surge tank, and one being cooled using the cold CO₂-depleted gas to prepare it for further sorbing operations.

16. The apparatus is claim 15 wherein the preheated carbon dioxide used to regenerate the bed and free the trapped carbon dioxide is heated using a portion of the thermal energy released by the combustion source.

17. The apparatus of claim 15 where said sorption beds utilize molecular sieves or activated carbon as sorbents.

18. The apparatus of claim 15 where a supply of CO₂ used to regenerate said molecular sieve is stored in a surge tank, and drawn from a source including but not limited to the combustion source exhaust.

19. The apparatus of claim 15 where the carbon dioxide source is flue gas.

20. The apparatus of claim 15 where additional thermal energy needed for the regeneration step is provided by additional power sources beyond the combustion that produced the CO₂ itself.

21. The apparatus of claim 20, wherein the additional power sources are drawn from alternatives including but not limited to combustion, nuclear, solar, geothermal, wind, tidal, and hydroelectric power.

22. The apparatus of claim 15 operating at pressures greater than 1 bar.

23. An apparatus for capturing CO₂ from a gas stream comprising:
a) A gas stream from a combustion source containing CO₂
b) Four beds containing a material that is a strong sorbent for carbon dioxide.
c) A surge tank for containing a supply water
d) A heat exchanger for heating the water to produce steam
e) A heat exchanger for cooling a gas stream that has been depleted in carbon dioxide, wherein:
f) The four beds are used in alternation, with one sorbing CO₂ from the CO₂ containing gas stream, one being desorbed of carbon dioxide using high temperature steam drawn from the steam generator, one being desorbed of water using high temperature exhaust gas from a combustion source, and one being cooled using the cold CO₂-depleted gas to prepare it for further carbon dioxide sorbing operations.

24. The apparatus is claim 23 wherein the steam used to free the trapped carbon dioxide is heated using a portion of the thermal energy released by the combustion source.

25. The apparatus of claim 23 where said sorption beds utilize molecular sieves or activated carbon as sorbents.

26. The apparatus of claim 23 where a supply of water used to expel carbon dioxide from said molecular sieve is stored in a surge tank, and drawn from a source including but not limited to the combustion source exhaust.

27. The apparatus of claim 23 where the carbon dioxide source is flue gas.

28. The apparatus of claim 23 where additional thermal energy needed for the water desorption step is provided by additional power sources beyond the combustion that produced the CO₂ itself.

29. The apparatus of claim 28, wherein the additional power sources are drawn from alternatives including but not limited to combustion, nuclear, solar, geothermal, wind, tidal, and hydroelectric power.

30. The apparatus of claim 23 operating at pressures greater than one bar.
